(19) United States
(12) Patent Application Publication
(10) Pub. No.: US 2025/0299196 A1
(43) Pub. Date: Sep. 25, 2025

(54) GENERATING WARNINGS FOR OPERATION EXECUTION

(71) Applicant: Capital One Services, LLC, McLean, VA (US)

(72) Inventors: Rahul BOPPANA, McLean, VA (US); Christopher GREGORY, Frederick, MD (US); Hamidreza TAVAKOLI, McLean, VA (US); Jonathon GRAY, McLean, VA (US); Anil SALGAONKAR, Wood Ridge, NJ (US)

(73) Assignee: Capital One Services, LLC, McLean, VA (US)

(21) Appl. No.: 18/614,315

(22) Filed: Mar. 22, 2024

(51) Int. Cl. G06F 11/07

(52) U.S. Cl. CPC G06Q 20/4016

(57) ABSTRACT

Methods and systems are described herein for generating warning displays during operation execution. In particular, when an operation request is received, an operation execution system may determine a set of potential causes for the operation and generate a set of selectable cause indicators for the set of potential causes. The cause indicators may be sent to a user device with the user being prompted to select one of the cause indicators. When a selection of a cause indicator is received, the operation execution system may generate a warning display to display to the user. The warning display may then be displayed to the user and the user may be enabled to proceed with the operation despite a risk level associated with the warning display.

### BACKGROUND

In recent years, the use of applications on mobile devices has increased exponentially. There are millions of mobile applications available to users. As more and more applications are being developed for mobile devices, developers have created applications with user interfaces that enable executing functions with a click of a button that previously required hours, if not days, to complete. It is now extremely easy to execute a function electronically that a user may not have meant to execute if that function had not been available for such easy execution. Accordingly, a mechanism is needed for generating warnings when executing functions/operations so that a user does not execute an operation (e.g., on a mobile device) inadvertently.

### SUMMARY

Therefore, methods and systems are described herein for generating warning displays for operation execution. An operation execution system may be used to perform operations disclosed herein. The operation execution system may receive (e.g., from a user device of a first user) an operation request that indicates that an operation is requested in relation to a second user. For example, the operation execution system may reside on a server device and may receive from a mobile device of the first user an operation request for an electronic data transfer. The electronic data transfer may be associated with the first user and the second user. In some embodiments, the operation request may include one or more parameters (e.g., parameters related to the data transfer).

The operation execution system may determine a set of potential causes for the operation. The set of potential causes may include frequently encountered potential causes. For example, the operation execution system may query a database to retrieve a plurality of potential causes, rank those causes based on frequency, and then select the set of potential causes (e.g., select causes with a highest frequency).

When the operation execution system determines the set of potential causes, the operation execution system may prompt a user to select a cause for the operation associated with the operation request. In particular, the operation execution system may generate a set of selectable cause indicators for the set of potential causes such that the first user may be enabled, on the user device, to select a cause indicator of the set of selectable cause indicators to indicate a cause for requesting the operation. For example, the operation execution system may generate a display to be displayed on a mobile device of the user (e.g., on a smartphone of the user). The display may include indicators (e.g., descriptions and/or names) for each cause of the set of causes. The indicators may be selectable by the first user. The first user may select one of the indicators, and the user selection may be communicated from the user's mobile device to the operation execution system.

In some embodiments, the operation request may include a request for a new user setup. Thus, the display and/or determination of the potential causes may be performed in response to or based on a request for a new user setup. In particular, the operation execution system may determine that the operation request includes a flag requesting a new user setup for the second user. In some embodiments, the flag may be one of the parameters of the operation request. In response to the flag within the operation request, the operation execution system may determine the set of potential causes for the operation.

When the user selects a particular cause indicator for a particular cause, the user device (e.g., a smartphone) may transmit the selection to the operation execution system. The operation execution system may receive, from the user device, a user selection of the cause indicator of the set of selectable cause indicators. The user selection may be an identifier associated with the selected cause indicator.

When the operation execution system receives the user selection, the operation execution system may build a warning display for the user. In particular, the operation execution system may, based on the cause indicator, determine a warning display of a plurality of warning displays to display to the first user. The warning display may warn the first user that the cause for requesting the operation is associated with a risk level. For example, the warning display may indicate that the user may want to refrain from initiating the operation and/or cancel the operation. That is, the operation execution system may retrieve warning data for the warning display associated with the selected cause. The warning data may include a risk level associated with the cause.

The operation execution system may then generate, for display on the user device, the warning display indicating the risk level associated with the cause. The warning display may enable the first user to execute the operation despite the risk level. In some embodiments, the warning display may be generated based on the parameters within the request. For example, the parameters may be compared to thresholds to determine data for the warning. In some embodiments, the parameters may be added to the warning display via a use of one or more templates. In some embodiments, the operation execution system may generate, as part of the warning display, one or more selectable elements. For example, the operation execution system may generate a “Cancel” selectable indicator which may be larger than the “Proceed” selectable indicator. This may indicate to the user that the user should cancel the operation in view of the risk level.

Various other aspects, features, and advantages of the system will be apparent through the detailed description and the drawings attached hereto. It is also to be understood that both the foregoing general description and the following detailed description are examples, and not restrictive of the scope of the disclosure. As used in the specification and in the claims, the singular forms of “a,” “an,” and “the” include plural referents unless the context clearly dictates otherwise. In addition, as used in the specification and the claims, the term “or” means “and/or” unless the context clearly dictates otherwise. Additionally, as used in the specification, “a portion” refers to a part of, or the entirety of (i.e., the entire portion), a given item (e.g., data), unless the context clearly dictates otherwise.

### BRIEF DESCRIPTION OF THE DRAWINGS

FIG. 1 shows an illustrative system for warning generation, in accordance with one or more embodiments of this disclosure.

FIG. 2 illustrates a data structure for an operation request, in accordance with one or more embodiments of this disclosure.

FIG. 3 illustrates an exemplary user interface displaying potential causes for the operation, in accordance with one or more embodiments of this disclosure.

FIG. 4 illustrates an exemplary user interface of a warning display, in accordance with one or more embodiments of this disclosure.

FIG. 5 illustrates an exemplary user interface displaying potential causes for the operation in response to a user selecting a new recipient, in accordance with one or more embodiments of this disclosure.

FIG. 6 illustrates a computing device, in accordance with one or more embodiments of this disclosure.

FIG. 7 is a flowchart of operations for generating a warning display, in accordance with one or more embodiments of this disclosure.

### DETAILED DESCRIPTION

In the following description, for the purposes of explanation, numerous specific details are set forth in order to provide a thorough understanding of the disclosed embodiments. It will be appreciated, however, by those having skill in the art, that the embodiments may be practiced without these specific details, or with an equivalent arrangement. In other cases, well-known models and devices are shown in block diagram form in order to avoid unnecessarily obscuring the disclosed embodiments. It should also be noted that the methods and systems disclosed herein are also suitable for applications unrelated to source code programming.

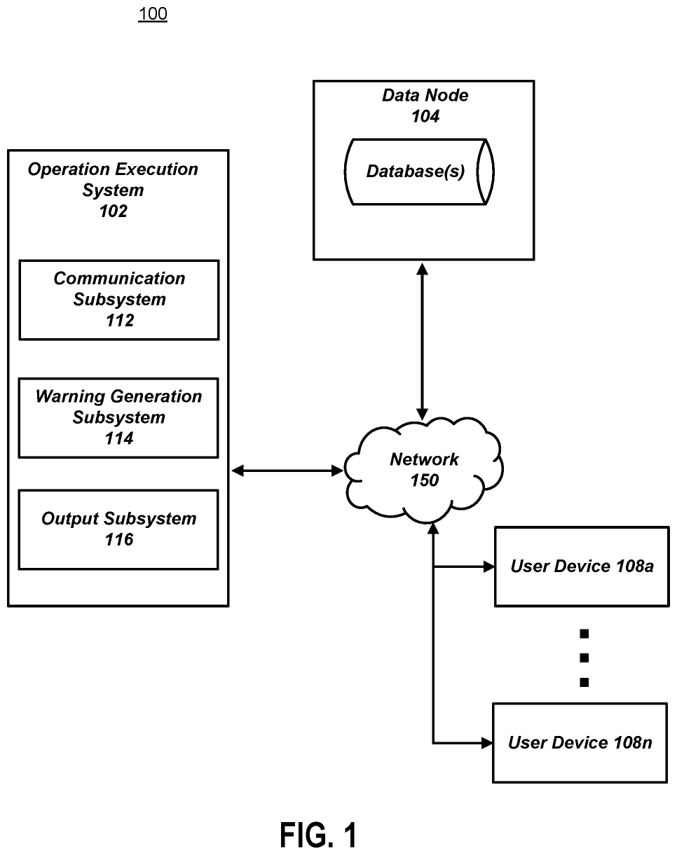

FIG. 1 is an example of an environment 100 for generating warning displays when executing operations. Environment 100 includes operation execution system 102, data node 104, and user devices 108a-108n. Operation execution system 102 may execute instructions for generating warning displays when executing operations. Operation execution system 102 may include software, hardware, or a combination of the two. For example, operation execution system 102 may be a physical server or a virtual server that is running on a physical computer system. In some embodiments, operation execution system 102 may be configured on a user device (e.g., a laptop computer, a smartphone, a desktop computer, an electronic tablet, or another suitable user device).

Data node 104 may store various data, including warning display data, template data, and/or other suitable data. Data node 104 may include software, hardware, or a combination of the two. For example, data node 104 may be a physical server, or a virtual server that is running on a physical computer system. In some embodiments, operation execution system 102 and data node 104 may reside on the same hardware and/or the same virtual server/computing device. Network 150 may be a local area network, a wide area network (e.g., the Internet), or a combination of the two. User devices 108a-108n may be end-user computing devices (e.g., desktop computers, laptops, electronic tablets, smartphones, and/or other computing devices used by end users). In some embodiments, each user may be associated with a corresponding user device. For example, the first user may be associated with user device 108a.

In some implementations, the operation execution system may be used to execute electronic payments between users (e.g., people) and entities (e.g., businesses, government agencies, etc.). In particular, a user may be using a mobile device to request that a payment be sent from the user's electronic account to another user's or entity's electronic account. When that request is received, the operation execution system may generate, for the user, some reasons for why the user is sending the payment. The reasons may be generated based on common scams being perpetrated at the time of the payment. The user may then select a reason and the operation execution system may generate a warning message about a scam related to the reason that the user selected.

Accordingly, operation execution system 102 may receive, from a user device of a first user, an operation request that indicates that an operation is requested in relation to a second user. Operation execution system 102 may receive the operation request using communication subsystem 112. Communication subsystem 112 may include software components, hardware components, or a combination of both. For example, communication subsystem 112 may include a network card (e.g., a wireless network card and/or a wired network card) that is associated with software to drive the card. In some embodiments, communication subsystem 112 may receive the operation request via data node 104 or from another computing device. In some embodiments, communication subsystem 112 may receive the operation request from one of user devices 108a-108n.

As discussed above, the operation request may be a request by a first user to make an electronic payment to a second user. The request may be made by the first user on a mobile device that is executing a banking application or another payment application. The mobile device may be communicating with operation execution system 102. The operation request may include one or more parameters. For example, the parameters may be electronic transaction parameters such as amount of the transfer, the target user account, and/or other parameters. Communication subsystem 112 may pass the operation request, or a pointer to the operation request in memory, to warning generation subsystem 114.

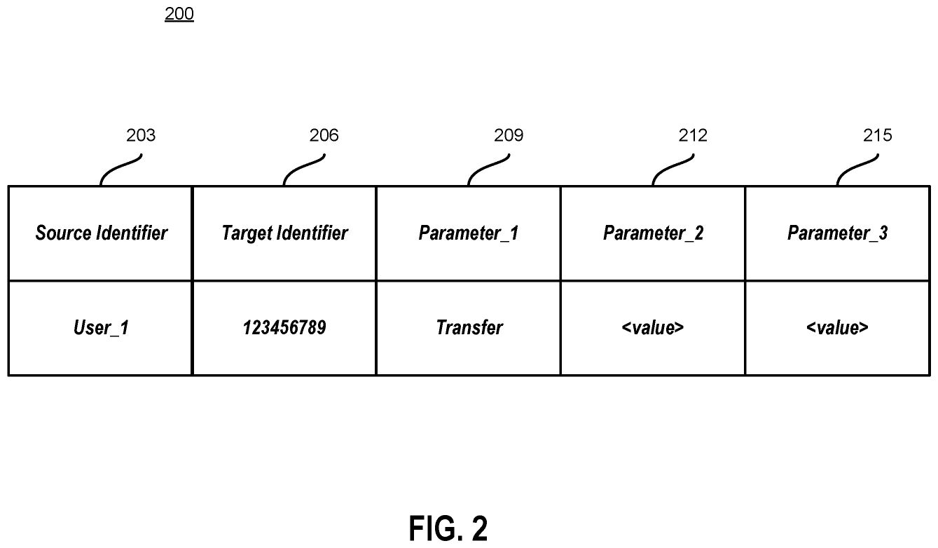

FIG. 2 illustrates a data structure 200 representing an exemplary operation request. Field 203 may include a source identifier, which may be an identifier associated with the first user. Field 206 may include a target identifier. In some embodiments, a target identifier may be a number, a string, or another suitable identifier. In one example, the target identifier may be an email address or a phone number of a user (e.g., a second user) to whom the electronic payment is being sent. Fields 209, 212, and 215 may store various parameters associated with the operation. For example, field 209 may include a type of operation. Field 212 may include an amount being transferred (e.g., amount in a particular currency). Other parameters may be added to the operation request.

Warning generation subsystem 114 may include software components, hardware components, or a combination of both. For example, warning generation subsystem 114 may include software components that access warning data including templates and may generate warning displays using the warning data. Warning generation subsystem 114 may access the operation request and in some instances the received parameters, for example, in memory.

When the operation request is received, warning generation subsystem 114 may ask the user to select a reason for performing the operation. In particular, warning generation subsystem 114 may determine a set of potential causes for the operation. The set of potential causes may include frequently encountered potential causes. For example, some potential causes for sending the payment from a first user to a second user may be “sending money to a friend or a family member,” “paying for a product,” “paying for an existing service,” “paying a financial institution,” “paying a government agency,” “returning money,” or another suitable reason. In some embodiments, warning generation subsystem 114 may enable a user to select “other” and enter a custom reason/cause for sending the payment.

In some embodiments, warning generation subsystem 114 may determine the set of potential causes based on current operation activity (e.g., common and/or frequent reasons for sending electronic payments). For example, warning generation subsystem 114 may have access to a database or a data structure storing various causes. These causes may be added to the database or the data structure based on current activity (e.g., other users selecting/entering different causes). In some embodiments, those causes may be reasons for sending a payment as discussed above. Warning generation subsystem 114 may select a set of causes based on the frequency of use. In some embodiments, warning generation subsystem 114 may select a number of causes (e.g., two, three, four, five, six, etc.) that are being used the most. Accordingly, warning generation subsystem 114 may determine, based on current operation activity, a set of potential causes for the operation. As discussed above, the current operation activity may include a plurality of potential causes. Furthermore, the set of potential causes may include most frequently encountered potential causes.

In some embodiments, the reasons/potential causes may be linked to various scams for stealing electronic funds from users. For example, a user may receive a message (e.g., an electronic message) demanding payment to a government agency (e.g., tax authorities) with instructions to use an electronic payment system. Thus, the cause or reason the user may enter may be a “payment to a government agency.” However, this cause/reason may be linked, within the database or a data structure, with a particular scam. The system may scan current activity (e.g., scam activity) and determine which scams are run most frequently. Based on the information regarding frequency of scams, the system may select the potential causes that correspond to the most frequent scams. For example, if one of the most frequent scams is a payment demand that is being made for a payment to a government agency, the warning generation subsystem 114 may select “payment to a government agency” as a potential cause to be included in the set of causes displayed to the first user (e.g., the user attempting to perform the operation/transaction).

In some embodiments, warning generation subsystem 114 may perform the following operations when determining the set of potential causes for the operation. Warning generation subsystem 114 may access, based on current operation activity, a plurality of potential causes. For example, the plurality of potential causes may be stored in a database on data node 104. Operation execution system 102 or another suitable system may be tracking various potential causes. In some embodiments, operation execution system 102 or another suitable system may track various causes for performing operations when different users select those causes. However, in some embodiments, operation execution system 102 or another suitable system may track scams linked to those potential causes.

Warning generation subsystem 114 may rank the plurality of potential causes based on frequency. For example, as operation execution system 102 or another suitable system tracks causes and/or scams, a frequency of those causes or scams may be tracked as well. Frequency may be represented as a number, a ratio, a percentage, or another suitable measure of frequency. Warning generation subsystem 114 may retrieve the frequencies. Frequencies may represent frequency of use of each potential cause or reason, or frequency of scams associated with each potential cause/reason. Warning generation subsystem 114 may then rank those causes and generate the set of potential causes that includes the most frequently encountered potential causes based on the ranking. For example, warning generation subsystem 114 may select six causes with the highest ranks.

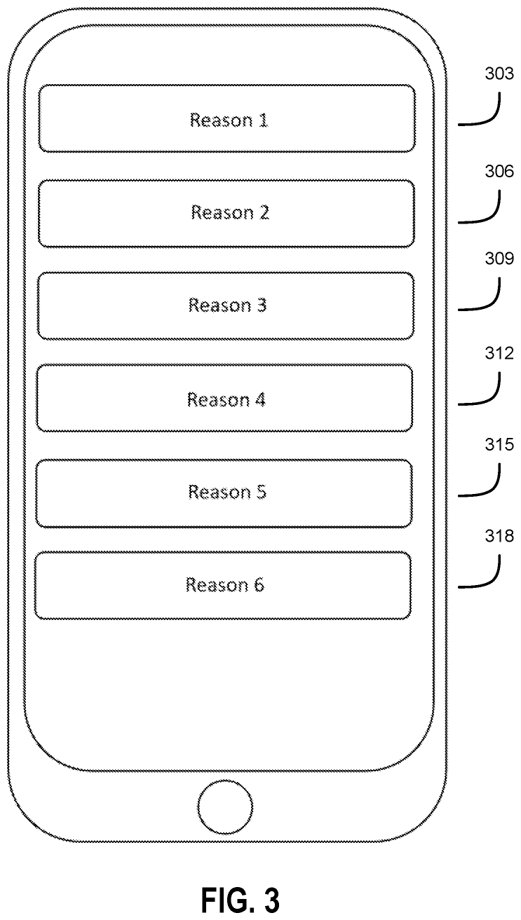

Warning generation subsystem 114 may then display, to the first user, a set of indicators representing the set of causes and enable the first user to select one of them. In particular, warning generation subsystem 114 may then generate a set of selectable cause indicators for the set of potential causes, such that the first user is enabled, on the user device, to select a cause indicator of the set of selectable cause indicators to indicate a cause for requesting the operation. In some embodiments, warning generation subsystem 114 may generate the set of selectable cause indicators to be displayed on a user's device (e.g., a mobile device such as a smartphone). FIG. 3 illustrates an exemplary user interface displaying potential causes for the operation. Areas 303, 306, 309, 312, 315, and 318 may represent descriptions of various causes/reasons for performing the operation. Those causes/reasons may be selectable by the first user (e.g., via a touch screen display of a mobile phone). Thus, warning generation subsystem 114 may cause the mobile device (e.g., of a first user) to generate a set of selectable cause indicators for the set of potential causes. As discussed above, the first user may be enabled to select a cause indicator of the set of selectable cause indicators to indicate a cause for requesting the operation.

When the first user selects a particular indicator, that selection may be sent to warning generation subsystem 114. Thus, warning generation subsystem 114 may receive, from the user device (e.g., a mobile device of the first user), a user selection of the cause indicator of the set of selectable cause indicators. The user selection may be received in a form of a cause identifier or in another suitable form or format. Warning generation subsystem 114 may receive the user selection and decode that user selection to match with a cause within the set of causes.

When the user selects a particular cause indicator and warning generation subsystem 114 receives that cause indicator, warning generation subsystem 114 may determine or generate a warning display corresponding to the selected cause indicator. In particular, warning generation subsystem 114 may, based on the cause indicator, determine a warning display of a plurality of warning displays to display to the first user. The warning display may warn the first user that the cause for requesting the operation is associated with a risk level.

In some embodiments, when determining or generating the warning display, warning generation subsystem 114 may take into account parameters within the operation request. In particular, warning generation subsystem 114 may retrieve a destination parameter associated with the operation. For example, warning generation subsystem 114 may access the parameters within the operation request and determine which parameter is the destination parameter. The destination parameter may be an identifier associated with the second user or an entity being represented by the second user. That is, the second user may be an entity or another type of user. In some embodiments, the second user is a second user account, which may be represented by an identifier. In some embodiments, the identifier may be an email address, a telephone number, or another suitable identifier.

Warning generation subsystem 114 may then determine whether the destination parameter matches the cause for requesting the operation. For example, if the cause for requesting an operation is payment to a vendor or a seller, warning generation subsystem 114 may determine whether the target parameter (e.g., corresponding to the recipient of the payment) is a seller of products. In another example, if the payment is to a government entity or agency, warning generation subsystem 114 may determine whether the target parameter (e.g., the identifier of the target user or account) is associated with the government entity. That is, warning generation subsystem 114 may match the type of entity associated with the second account (e.g., second user) to the type of entity associated with the cause/reason for performing an operation (e.g., sending a payment).

Warning generation subsystem 114 may then, based on the destination parameter matching the cause, generate a first warning display. For example, if the cause matches the destination parameter, warning generation subsystem 114 may add to the warning display that there is a match. However, if there is no match, warning generation subsystem 114 may generate a different warning display. In particular, warning generation subsystem 114 may, based on the destination parameter not matching the cause, generate a second warning display. The second warning display may be associated with a higher degree warning than the first warning display. For example, if the cause does not match the destination parameter, warning generation subsystem 114 may generate a warning display that will look different and warn the user further that the payment may be to a scammer using a particular account.

In some embodiments, warning generation subsystem 114 may generate a warning display with a risk indicator. In particular, warning generation subsystem 114 may, based on the cause indicator and the one or more parameters, determine a warning display of a plurality of warning displays to display to the first user. The warning display may warn the first user that the cause for requesting the operation is associated with a risk level higher than a threshold. For example, if the cause selected by the user indicates a payment to a government agency, but the government agency is not known to receive payments using this particular system, warning generation subsystem 114 may determine that the risk level for the payment is above a threshold and may add the information to the warning display. In some embodiments, when the risk level is higher than another threshold, warning generation subsystem 114 may prevent the user from continuing with the operation (e.g., payment) by, for example, taking away the proceed option and only leaving a cancel option on the warning display. In some embodiments, warning generation subsystem 114 may adjust the risk level based on whether the cause matches the destination parameter. That is, if the cause matches the destination parameter, the risk level may be lowered (e.g., below the threshold). However, if the cause does not match the destination parameter, the risk level may be increased (e.g., above the threshold).

In some embodiments, warning generation subsystem 114 may perform the following operations when generating a warning display. These operations may be performed by warning generation subsystem 114 to take into account a user identifier of the second user (e.g., a target account) and whether the target account matches the cause indicator. As discussed above, one way to perform a matching is based on the type of account and the type of account associated with the cause indicator. However, warning generation subsystem 114 may match on other data as well. Thus, warning generation subsystem 114 may determine an identifier associated with the second user. As discussed above, an identifier may be an email address, a telephone number, or another suitable identifier.

Warning generation subsystem 114 may then determine whether the identifier associated with the second user matches the cause indicator selected by the first user. For example, if the cause selected is a payment to a government agency, warning generation subsystem 114 may determine whether the email address associated with the second user (e.g., the second user account) has a .gov ending indicating a government agency. In some embodiments, warning generation subsystem 114 may generally compare parameters associated with the cause (e.g., as stored within a database on data node 104) with parameters associated with the second user (e.g., account data for the second user). Based on determining that the identifier associated with the second user matches the cause indicator selected by the first user, warning generation subsystem 114 may include a match indicator in the warning display. That is, the match indicator may give the user more assurances that the payment recipient is not a scammer.

In some embodiments, warning generation subsystem 114 may, based on determining that the identifier associated with the second user does not match the cause indicator selected by the first user, include a mismatch indicator in the warning display. For example, warning generation subsystem 114 may display a large indicator on the warning display that the payment is likely to be a scam, warning the user that the user may lose money if the user proceeds with the payment. In some embodiments, warning generation subsystem 114 may remove the proceed button from the warning display and only enable the user to cancel the payment.

In some embodiments, warning generation subsystem 114 may generate the warning display based on the plurality of parameters associated with a selected cause. In particular, warning generation subsystem 114 may determine, based on the cause indicator, an identifier associated with a corresponding cause. The identifier may be a number, a string, or another suitable parameter. Warning generation subsystem 114 may then retrieve a plurality of cause parameters associated with the corresponding cause. For example, warning generation subsystem 114 may retrieve the cause parameters from a database on data node 104. In some embodiments, the cause parameters may include data about a particular scam (e.g., description of the scam, images associated with the scam). The data may be stored in a database and may be linked with the identifier of the cause. Warning generation subsystem 114 may then generate the warning display based on the plurality of cause parameters. That is, the warning display may indicate the details of a particular scam.

In some embodiments, warning generation subsystem 114 may use a combination of templates and risk level for generating warning displays. In particular, warning generation subsystem 114 may select a template of a plurality of templates associated with the risk level of a plurality of risk levels. As discussed above, the risk level may be determined based on the cause selected by the first user. Each risk level may be associated with a template. For example, higher risk levels may be associated with templates having different language and images than templates associated with lower risk levels. Warning generation subsystem 114 may then retrieve a plurality of operation parameters from the operation request. For example, the operation parameters may include a user identifier of the target account (e.g., a second user), a payment amount, and/or other operation parameters. Warning generation subsystem 114 may then generate the warning display based on the plurality of operation parameters and the template. For example, the template may include fields where the operation parameters are to be inserted. Thus, warning generation subsystem 114 may insert the values of the operation parameters into those fields to generate the warning display.

When the warning display has been determined or generated, warning generation subsystem 114 may pass the warning display to output subsystem 116 for displaying the warning display to the user. Output subsystem 116 may include software components, hardware components, or a combination of both. For example, output subsystem 116 may include software components that access data in memory and/or storage, and may use one or more processors to perform its operations. In particular, output subsystem 116 may generate, for display on the user device, the warning display indicating the risk level associated with the cause. The warning display may enable the first user to execute the operation despite the risk level. In some embodiments, output subsystem 116 may cause the mobile device to display the warning display. In particular, output subsystem 116 may cause the mobile device to display the warning display indicating the risk level associated with the cause. The warning display may enable the first user to execute the operation.

In some embodiments, output subsystem 116 may vary the size or placement of operation execution elements on the screen based on the risk level. In particular, output subsystem 116 may determine whether the risk level meets a threshold. For example, output subsystem 116 may retrieve the threshold and compare the threshold to the risk level. Based on determining that the risk level meets the threshold, output subsystem 116 may generate for display a cancellation display element that is more prominent than an execution display element. For example, if the risk is high (e.g., higher than the threshold), the cancel display element may be larger, may have brighter colors, and/or may be located in a more prominent place than the proceed display element. Based on determining that the risk level does not meet the threshold, output subsystem 116 may generate for display the cancellation display element that is less prominent than the execution display element.

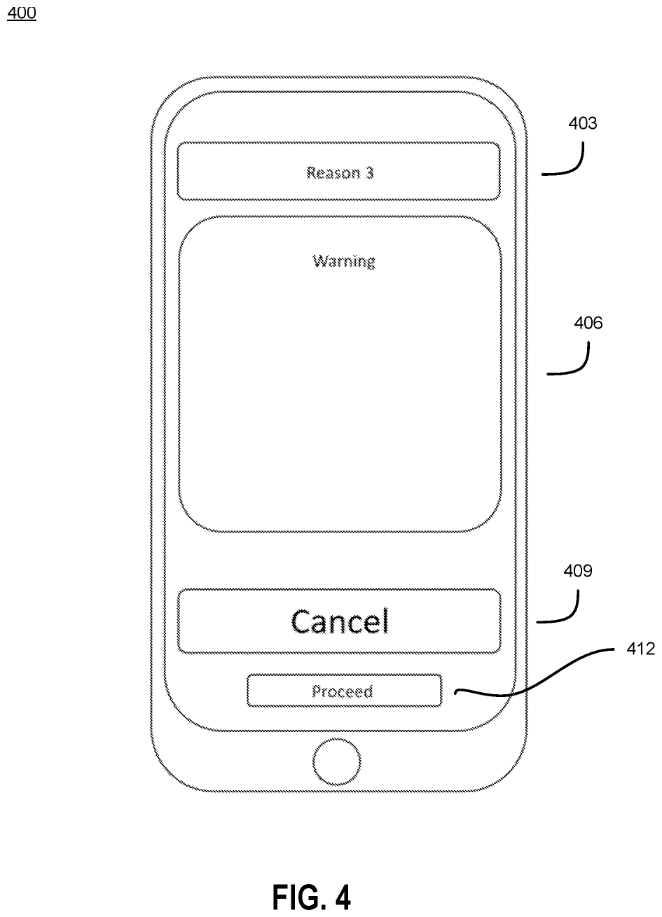

FIG. 4 illustrates an exemplary warning display 400. Warning display 400 may include cause 403, which may be a cause/reason selected by the first user. In addition, warning display 400 may include warning area 406. Warning area 406 may include elements described above (e.g., operation parameters, risk level, template data, and/or other suitable data). Warning display 400 may also include a “Cancel” element 409 that is more pronounced than “Proceed” element 412. Accordingly, warning display 400 may illustrate a risk level that is above the threshold, as described above. Thus, when the user selects the proceed element, output subsystem 116 may cause the operation to be executed according to the user input.

In some embodiments, operation execution system 102 may execute the operations to generate and display the warning display based on a first user attempting to perform the operation in relation to a new user (e.g., a user that the first user has not transacted with before). That is, there is a higher risk that the first user is going to be scammed. In particular, operation execution system 102 may determine that the operation request includes a flag requesting a new user setup for the second user. For example, when the user initiates an operation (e.g., from a mobile device), the user may select a new recipient (e.g., a recipient that the first user has not transacted with before). That action may be indicated by a particular flag within the operation request. For example, the flag may be one of the parameters received within the operation request. Based on the flag within the operation request, operation execution system 102 may trigger the determination of potential causes and/or the rest of the process. Furthermore, operation execution system 102 may set a risk level that is above the threshold. In particular, in response to the flag within the operation request, operation execution system 102 may determine the set of potential causes for the operation with risk levels above a threshold.

In some embodiments, the first user may be performing the operation in relation to a known or related user. Thus, operation execution system 102 may set a lower risk level. In particular, operation execution system 102 may determine that the operation request includes a flag indicating that the first user and the second user are related. The flag may be set when a user has completed operations in relation to a second user before. In some embodiments, the flag may be set based on the first user's selection of the second user from an address book or from another source of known users. Accordingly, in response to the flag within the operation request, operation execution system 102 may determine the set of potential causes for the operation with risk levels below a threshold. That is, among the plurality of potential causes, as described above, each cause may have a particular risk level (e.g., stored in a database on data node 104). Thus, operation execution system 102 may determine the risk level and retrieve the causes that match the determined risk level. If the users are related, as discussed above, operation execution system 102 may determine a lower risk level than if the users are not related.

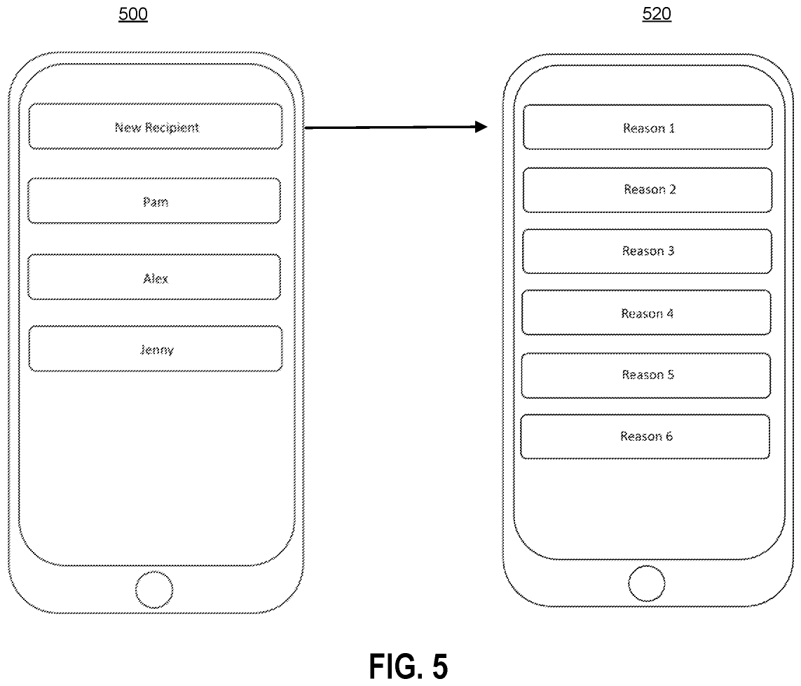

FIG. 5 illustrates an exemplary user interface displaying potential causes for the operation in response to a user selecting a new recipient. FIG. 5 includes a display 500 that enables a user to select a recipient including a new recipient. When a new recipient is selected from display 500, display 520 may be generated. That is, the warning display generation process may be triggered by selecting a new recipient as illustrated in FIG. 5.

### Computing Environment

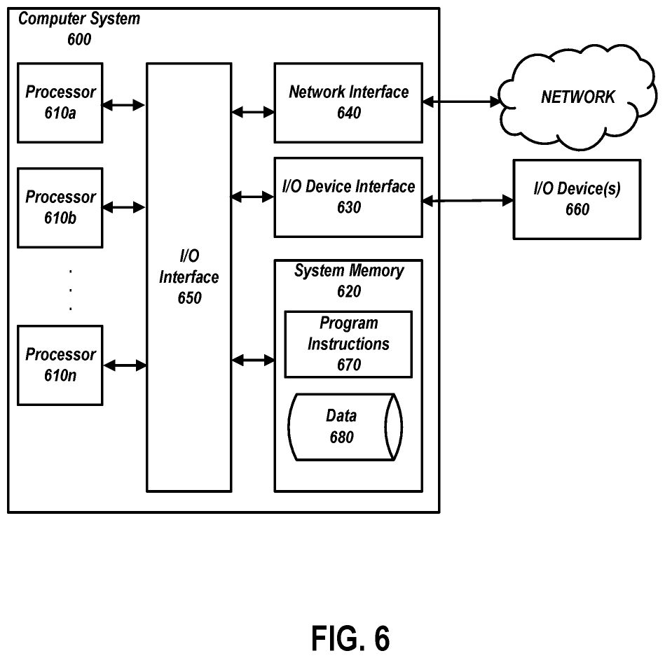

FIG. 6 shows an example computing system that may be used in accordance with some embodiments of this disclosure. In some instances, computing system 600 is referred to as a computer system 600. A person skilled in the art would understand that those terms may be used interchangeably. The components of FIG. 6 may be used to perform some or all operations discussed in relation to FIGS. 1-5. Furthermore, various portions of the systems and methods described herein may include or be executed on one or more computer systems similar to computing system 600. Further, processes and modules described herein may be executed by one or more processing systems similar to that of computing system 600.

Computing system 600 may include one or more processors (e.g., processors 610a-610n) coupled to system memory 620, an input/output (I/O) device interface 630, and a network interface 640 via an I/O interface 650. A processor may include a single processor, or a plurality of processors (e.g., distributed processors). A processor may be any suitable processor capable of executing or otherwise performing instructions. A processor may include a central processing unit (CPU) that carries out program instructions to perform the arithmetical, logical, and input/output operations of computing system 600. A processor may execute code (e.g., processor firmware, a protocol stack, a database management system, an operating system, or a combination thereof) that creates an execution environment for program instructions. A processor may include a programmable processor. A processor may include general or special purpose microprocessors. A processor may receive instructions and data from a memory (e.g., system memory 620). Computing system 600 may be a uni-processor system including one processor (e.g., processor 610a), or a multi-processor system including any number of suitable processors (e.g., 610a-610n). Multiple processors may be employed to provide for parallel or sequential execution of one or more portions of the techniques described herein. Processes, such as logic flows, described herein may be performed by one or more programmable processors executing one or more computer programs to perform functions by operating on input data and generating corresponding output. Processes described herein may be performed by, and apparatus can also be implemented as, special purpose logic circuitry, e.g., an FPGA (field-programmable gate array) or an ASIC (application-specific integrated circuit). Computing system 600 may include a plurality of computing devices (e.g., distributed computer systems) to implement various processing functions.

I/O device interface 630 may provide an interface for connection of one or more I/O devices 660 to computer system 600. I/O devices may include devices that receive input (e.g., from a user) or output information (e.g., to a user). I/O devices 660 may include, for example, a graphical user interface presented on displays (e.g., a cathode ray tube (CRT) or liquid crystal display (LCD) monitor), pointing devices (e.g., a computer mouse or trackball), keyboards, keypads, touchpads, scanning devices, voice recognition devices, gesture recognition devices, printers, audio speakers, microphones, cameras, or the like. I/O devices 660 may be connected to computer system 600 through a wired or wireless connection. I/O devices 660 may be connected to computer system 600 from a remote location. I/O devices 660 located on remote computer systems, for example, may be connected to computer system 600 via a network and network interface 640.

Network interface 640 may include a network adapter that provides for connection of computer system 600 to a network. Network interface 640 may facilitate data exchange between computer system 600 and other devices connected to the network. Network interface 640 may support wired or wireless communication. The network may include an electronic communication network, such as the Internet, a local area network (LAN), a wide area network (WAN), a cellular communications network, or the like.

System memory 620 may be configured to store program instructions 670 or data 680. Program instructions 670 may be executable by a processor (e.g., one or more of processors 610a-610n) to implement one or more embodiments of the present techniques. Program instructions 670 may include modules of computer program instructions for implementing one or more techniques described herein with regard to various processing modules. Program instructions may include a computer program (which in certain forms is known as a program, software, software application, script, or code). A computer program may be written in a programming language, including compiled or interpreted languages, or declarative or procedural languages. A computer program may include a unit suitable for use in a computing environment, including as a stand-alone program, a module, a component, or a subroutine. A computer program may or may not correspond to a file in a file system. A program may be stored in a portion of a file that holds other programs or data (e.g., one or more scripts stored in a markup language document), in a single file dedicated to the program in question, or in multiple coordinated files (e.g., files that store one or more modules, subprograms, or portions of code). A computer program may be deployed to be executed on one or more computer processors located locally at one site, or distributed across multiple remote sites and interconnected by a communication network.

System memory 620 may include a tangible program carrier having program instructions stored thereon. A tangible program carrier may include a non-transitory, computer-readable storage medium. A non-transitory, computer-readable storage medium may include a machine-readable storage device, a machine-readable storage substrate, a memory device, or any combination thereof. A non-transitory, computer-readable storage medium may include non-volatile memory (e.g., flash memory, ROM, PROM, EPROM, EEPROM), volatile memory (e.g., random access memory (RAM), static random access memory (SRAM), synchronous dynamic RAM (SDRAM)), bulk storage memory (e.g., CD-ROM and/or DVD-ROM, hard drives), or the like. System memory 620 may include a non-transitory, computer-readable storage medium that may have program instructions stored thereon that are executable by a computer processor (e.g., one or more of processors 610a-610n) to cause the subject matter and the functional operations described herein. A memory (e.g., system memory 620) may include a single memory device and/or a plurality of memory devices (e.g., distributed memory devices).

I/O interface 650 may be configured to coordinate I/O traffic between processors 610a-610n, system memory 620, network interface 640, I/O devices 660, and/or other peripheral devices. I/O interface 650 may perform protocol, timing, or other data transformations to convert data signals from one component (e.g., system memory 620) into a format suitable for use by another component (e.g., processors 610a-610n). I/O interface 650 may include support for devices attached through various types of peripheral buses, such as a variant of the Peripheral Component Interconnect (PCI) bus standard or the Universal Serial Bus (USB) standard.

Embodiments of the techniques described herein may be implemented using a single instance of computer system 600, or multiple computer systems 600 configured to host different portions or instances of embodiments. Multiple computer systems 600 may provide for parallel or sequential processing/execution of one or more portions of the techniques described herein.

Those skilled in the art will appreciate that computer system 600 is merely illustrative, and is not intended to limit the scope of the techniques described herein. Computer system 600 may include any combination of devices or software that may perform or otherwise provide for the performance of the techniques described herein. For example, computer system 600 may include or be a combination of a cloud-computing system, a data center, a server rack, a server, a virtual server, a desktop computer, a laptop computer, a tablet computer, a server device, a client device, a mobile telephone, a personal digital assistant (PDA), a mobile audio or video player, a game console, a vehicle-mounted computer, a Global Positioning System (GPS), or the like. Computer system 600 may also be connected to other devices that are not illustrated, or may operate as a stand-alone system. In addition, the functionality provided by the illustrated components may, in some embodiments, be combined in fewer components, or distributed in additional components. Similarly, in some embodiments, the functionality of some of the illustrated components may not be provided, or other additional functionality may be available.

### Operation Flow

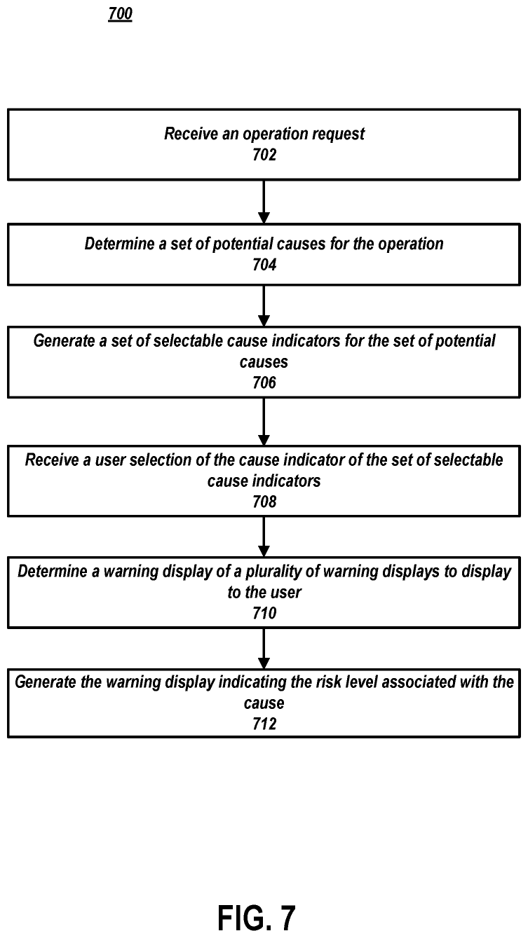

FIG. 7 is a flowchart 700 of operations for generating a warning display. The operations of FIG. 7 may use components described in relation to FIG. 6. In some embodiments, operation execution system 102 may include one or more components of computer system 600. At 702, operation execution system 102 receives an operation request. For example, the operation execution system 102 may receive the operation request from data node 104 or from one of user devices 108a-108n. Operation execution system 102 may receive the operation request over network 150 using network interface 640.

At 704, operation execution system 102 determines a set of potential causes for the operation. Operation execution system 102 may use one or more processors 610a, 610b, and/or 610n to perform the determination. At 706, operation execution system 102 generates a set of selectable cause indicators for the set of potential causes. For example, operation execution system 102 may use one or more processors 610a-610n to perform the operation and store the results in system memory 620.

At 708, operation execution system 102 receives a user selection of the cause indicator of the set of selectable cause indicators. For example, the operation execution system 102 may receive the user selection of the cause indicator from one of user devices 108a-108n. Operation execution system 102 may receive the user selection of the cause indicator over network 150 using network interface 640. At 710, operation execution system 102 determines a warning display of a plurality of warning displays to display to the user. Operation execution system 102 may use one or more processors 610a, 610b, and/or 610n to perform the determination. At 712, operation execution system 102 generates the warning display indicating the risk level associated with the cause. Operation execution system 102 may use one or more processors 610a, 610b, and/or 610n to perform the generation and store the results in system memory 620.

Although the present invention has been described in detail for the purpose of illustration based on what is currently considered to be the most practical and preferred embodiments, it is to be understood that such detail is solely for that purpose and that the invention is not limited to the disclosed embodiments, but, on the contrary, is intended to cover modifications and equivalent arrangements that are within the scope of the appended claims. For example, it is to be understood that the present invention contemplates that, to the extent possible, one or more features of any embodiment can be combined with one or more features of any other embodiment.

The above-described embodiments of the present disclosure are presented for purposes of illustration, and not of limitation, and the present disclosure is limited only by the claims which follow. Furthermore, it should be noted that the features and limitations described in any one embodiment may be applied to any other embodiment herein, and flowcharts or examples relating to one embodiment may be combined with any other embodiment in a suitable manner, done in different orders, or done in parallel. In addition, the systems and methods described herein may be performed in real time. It should also be noted that the systems and/or methods described above may be applied to, or used in accordance with, other systems and/or methods.

The present techniques will be better understood with reference to the following enumerated embodiments:

1. A method comprising: receiving, from a user device of a first user, an operation request that indicates that an operation is requested in relation to a second user; determining a set of potential causes for the operation, wherein the set of potential causes comprises frequently encountered potential causes; generating a set of selectable cause indicators for the set of potential causes, wherein the first user is enabled, on the user device, to select a cause indicator of the set of selectable cause indicators to indicate a cause for requesting the operation; receiving, from the user device, a user selection of the cause indicator of the set of selectable cause indicators; based on the cause indicator, determining a warning display of a plurality of warning displays to display to the first user, wherein the warning display warns the first user that the cause for requesting the operation is associated with a risk level; and generating, for display on the user device, the warning display indicating the risk level associated with the cause, wherein the warning display enables the first user to execute the operation despite the risk level.

2. Any of the preceding embodiments, wherein the operation request comprises one or more parameters, and wherein the warning display is determined based on the one or more parameters.

3. Any of the preceding embodiments, wherein determining the warning display based on the one or more parameters further comprises: retrieving a destination parameter associated with the operation; determining whether the destination parameter matches the cause for requesting the operation; based on the destination parameter matching the cause, generating a first warning display; and based on the destination parameter not matching the cause, generating a second warning display, wherein the second warning display is associated with a higher degree warning than the first warning display.

4. Any of the preceding embodiments, wherein determining the set of potential causes for the operation further comprises: accessing, based on current operation activity, a plurality of potential causes; ranking the plurality of potential causes based on frequency; and generating the set of potential causes comprising most frequently encountered potential causes based on a rank.

5. Any of the preceding embodiments, wherein determining the warning display of the plurality of warning displays further comprises: determining, based on the cause indicator, an identifier associated with a corresponding cause; retrieving a plurality of cause parameters associated with the corresponding cause; and generating the warning display based on the plurality of cause parameters.

6. Any of the proceeding embodiments, wherein receiving the operation request that indicates that the operation is requested in relation to the second user further comprises: determining that the operation request comprises a flag requesting a new user setup for the second user; and in response to the flag within the operation request, determining the set of potential causes for the operation with risk levels above a threshold.

7. Any of the preceding embodiments, wherein receiving the operation request that indicates that the operation is requested in relation to the second user further comprises: determining that the operation request comprises a flag indicating that the first user and the second user are related; and in response to the flag within the operation request, determining the set of potential causes for the operation with risk levels below a threshold.

8. Any of the preceding embodiments, further comprising: determining an identifier associated with the second user; determining whether the identifier associated with the second user matches the cause indicator selected by the first user; and based on determining that the identifier associated with the second user matches the cause indicator selected by the first user, including a match indicator in the warning display.

9. Any of the preceding embodiments, further comprising: based on determining that the identifier associated with the second user does not match the cause indicator selected by the first user, including a mismatch indicator in the warning display.

10. Any of the preceding embodiments, wherein generating the warning display indicating the risk level associated with the cause further comprises: selecting a template of a plurality of templates associated with the risk level of a plurality of risk levels; retrieving a plurality of operation parameters from the operation request; and generating the warning display based on the plurality of operation parameters and the template.

11. Any of the preceding embodiments, wherein generating, for display on the user device, the warning display indicating the risk level associated with the cause further comprises: determining whether the risk level meets a threshold; based on determining that the risk level meets the threshold, generating for display a cancellation display element that is more prominent than an execution display element; and based on determining that the risk level does not meet the threshold, generating for display the cancellation display element that is less prominent than the execution display element.

12. A tangible, non-transitory, machine-readable medium storing instructions that, when executed by a data processing apparatus, cause the data processing apparatus to perform operations comprising those of any of embodiments 1-11.

13. A system comprising: one or more processors; and memory storing instructions that, when executed by the processors, cause the processors to effectuate operations comprising those of any of embodiments 1-11.

14. A system comprising means for performing any of embodiments 1-11.

15. A system comprising cloud-based circuitry for performing any of embodiments 1-11.

What is claimed is:

1. A system for warning generation, the system comprising:
one or more processors; and
a non-transitory, computer-readable storage medium storing instructions, which when executed by the one or more processors cause the one or more processors to:
receive, from a mobile device associated with a first user, an operation request that indicates that an operation is requested in relation to a second user, wherein the operation request comprises one or more parameters;
determine, based on current operation activity, a set of potential causes for the operation, wherein the current operation activity comprises a plurality of potential causes, and wherein the set of potential causes comprises most frequently encountered potential causes;
cause the mobile device to generate a set of selectable cause indicators for the set of potential causes, wherein the first user is enabled to select a cause indicator of the set of selectable cause indicators to indicate a cause for requesting the operation;
receive, from the mobile device, a user selection of the cause indicator of the set of selectable cause indicators;
based on the cause indicator and the one or more parameters, determine a warning display of a plurality of warning displays to display to the first user, wherein the warning display warns the first user that the cause for requesting the operation is associated with a risk level higher than a threshold;
cause the mobile device to display the warning display indicating the risk level associated with the cause, wherein the warning display enables the first user to execute the operation; and
execute the operation based on a user input.

2. A method comprising:
receiving, from a user device of a first user, an operation request that indicates that an operation is requested in relation to a second user;
determining a set of potential causes for the operation, wherein the set of potential causes comprises frequently encountered potential causes;
generating a set of selectable cause indicators for the set of potential causes, wherein the first user is enabled, on the user device, to select a cause indicator of the set of selectable cause indicators to indicate a cause for requesting the operation;
receiving, from the user device, a user selection of the cause indicator of the set of selectable cause indicators;
based on the cause indicator, determining a warning display of a plurality of warning displays to display to the first user, wherein the warning display warns the first user that the cause for requesting the operation is associated with a risk level; and
generating, for display on the user device, the warning display indicating the risk level associated with the cause, wherein the warning display enables the first user to execute the operation despite the risk level.

3. The method of claim 2, wherein the operation request comprises one or more parameters, and wherein the warning display is determined based on the one or more parameters.

4. The method of claim 3, wherein determining the warning display based on the one or more parameters further comprises:
retrieving a destination parameter associated with the operation;
determining whether the destination parameter matches the cause for requesting the operation;
based on the destination parameter matching the cause, generating a first warning display; and
based on the destination parameter not matching the cause, generating a second warning display, wherein the second warning display is associated with a higher degree warning than the first warning display.

5. The method of claim 2, wherein determining the set of potential causes for the operation further comprises:
accessing, based on current operation activity, a plurality of potential causes;
ranking the plurality of potential causes based on frequency; and
generating the set of potential causes comprising most frequently encountered potential causes based on a rank.

6. The method of claim 2, wherein determining the warning display of the plurality of warning displays further comprises:
determining, based on the cause indicator, an identifier associated with a corresponding cause;
retrieving a plurality of cause parameters associated with the corresponding cause; and
generating the warning display based on the plurality of cause parameters.

7. The method of claim 6, wherein receiving the operation request that indicates that the operation is requested in relation to the second user further comprises:
determining that the operation request comprises a flag requesting a new user setup for the second user; and
in response to the flag within the operation request, determining the set of potential causes for the operation with risk levels above a threshold.

8. The method of claim 6, wherein receiving the operation request that indicates that the operation is requested in relation to the second user further comprises:
determining that the operation request comprises a flag indicating that the first user and the second user are related; and
in response to the flag within the operation request, determining the set of potential causes for the operation with risk levels below a threshold.

9. The method of claim 2, further comprising:
determining an identifier associated with the second user;
determining whether the identifier associated with the second user matches the cause indicator selected by the first user; and
based on determining that the identifier associated with the second user matches the cause indicator selected by the first user, including a match indicator in the warning display.

10. The method of claim 9, further comprising:
based on determining that the identifier associated with the second user does not match the cause indicator selected by the first user, including a mismatch indicator in the warning display.

11. The method of claim 2, wherein generating the warning display indicating the risk level associated with the cause further comprises:
selecting a template of a plurality of templates associated with the risk level of a plurality of risk levels;
retrieving a plurality of operation parameters from the operation request; and
generating the warning display based on the plurality of operation parameters and the template.

12. The method of claim 2, wherein generating, for display on the user device, the warning display indicating the risk level associated with the cause further comprises:
determining whether the risk level meets a threshold;
based on determining that the risk level meets the threshold, generating for display a cancellation display element that is more prominent than an execution display element; and
based on determining that the risk level does not meet the threshold, generating for display the cancellation display element that is less prominent than the execution display element.

13. One or more non-transitory, computer-readable storage media storing instructions, which when executed by one or more processors cause operations comprising:
receiving, from a first user, an operation request that indicates that an operation is requested in relation to a second user;
determining a set of potential causes for the operation, wherein the set of potential causes comprises frequently encountered potential causes;
generating a set of selectable cause indicators for the set of potential causes, wherein the first user is enabled to select a cause indicator of the set of selectable cause indicators to indicate a cause for requesting the operation;
receiving a user selection of the cause indicator of the set of selectable cause indicators;
based on the cause indicator, determining a warning display of a plurality of warning displays to display to the first user, wherein the warning display warns the first user that the cause for requesting the operation is associated with a risk level; and
generating, for display to the first user, the warning display indicating the risk level associated with the cause, wherein the warning display enables the first user to execute the operation despite the risk level.

14. The one or more non-transitory, computer-readable storage media of claim 13, wherein the operation request comprises one or more parameters, and wherein the warning display is determined based on the one or more parameters.

15. The one or more non-transitory, computer-readable storage media of claim 14, wherein the instructions for determining the warning display based on the one or more parameters further cause the one or more processors to perform operations comprising:
retrieving a destination parameter associated with the operation;
determining whether the destination parameter matches the cause for requesting the operation;
based on the destination parameter matching the cause, generating a first warning display; and
based on the destination parameter not matching the cause, generating a second warning display, wherein the second warning display is associated with a higher degree warning than the first warning display.

16. The one or more non-transitory, computer-readable storage media of claim 13, wherein the instructions for determining the set of potential causes for the operation further cause the one or more processors to perform operations comprising:
accessing, based on current operation activity, a plurality of potential causes;
ranking the plurality of potential causes based on frequency; and
generating the set of potential causes comprising most frequently encountered potential causes based on a rank.

17. The one or more non-transitory, computer-readable storage media of claim 13, wherein the instructions for determining the warning display of the plurality of warning displays further cause the one or more processors to perform operations comprising:
determining, based on the cause indicator, an identifier associated with a corresponding cause;
retrieving a plurality of cause parameters associated with the corresponding cause; and
generating the warning display based on the plurality of cause parameters.

18. The one or more non-transitory, computer-readable storage media of claim 17, wherein the instructions for receiving the operation request that indicates that the operation is requested in relation to the second user further cause the one or more processors to perform operations comprising:
determining that the operation request comprises a flag requesting a new user setup for the second user; and
in response to the flag within the operation request, determining the set of potential causes for the operation with risk levels above a threshold.

19. The one or more non-transitory, computer-readable storage media of claim 17, wherein the instructions for receiving the operation request that indicates that the operation is requested in relation to the second user further cause the one or more processors to perform operations comprising:
determining that the operation request comprises a flag indicating that the first user and the second user are related; and
in response to the flag within the operation request, determining the set of potential causes for the operation with risk levels below a threshold.

20. The one or more non-transitory, computer-readable storage media of claim 13, wherein the instructions further cause the one or more processors to perform operations comprising:
determining an identifier associated with the second user;
determining whether the identifier associated with the second user matches the cause indicator selected by the first user; and
based on determining that the identifier associated with the second user matches the cause indicator selected by the first user, including a match indicator in the warning display.
